(19) United States
(12) Patent Application Publication
(10) Pub. No.: US 2009/0105895 A1
(43) Pub. Date: Apr. 23, 2009

(54) Fuel Cell Vehicle

(76) Inventor: Masahiro Shige, Osaka-fu (JP)

Correspondence Address: KENYON & KENYON LLP, 1500 K STREET N.W., SUITE 700, WASHINGTON, DC, 20005, US

(21) Appl. No.: 11/988,392

(22) PCT Filed: Jul. 19, 2006
(86) PCT No.: PCT/JP2006/314301

§ 371 Date: Jan. 7, 2008

(30) Foreign Application Priority Data
Aug. 4, 2005 (JP) 2005-226684

(51) Int. Cl. B60L 11/18; G06F 17/00

(52) U.S. Cl. 701/22; 701/70

(57) ABSTRACT

In a fuel cell vehicle according to one aspect of the invention, an amount of battery assist for a fuel cell stack is adequately set according to the setting of a mode position and an accelerator opening change rate. The driver's requirement for abrupt acceleration is inferred from a large value of the accelerator opening change rate. In this case, the amount of battery assist is increased to give a sufficient acceleration feeling to the driver. The driver's requirement for moderate acceleration is inferred, on the other hand, from a small value of the accelerator opening change rate. In this case, the amount of battery assist is reduced to restrict the acceleration and improve the fuel consumption. The setting of the mode position to a sports mode suggests the driver's preference to the acceleration over the fuel consumption. The amount of battery assist is thus increased to ensure the sufficient acceleration feeling. The setting of the mode position to an economic mode, on the other hand, suggests the driver's preference to the fuel consumption over the acceleration. The amount of battery assist is thus reduced to improve the fuel consumption.

### TECHNICAL FIELD

The present invention relates to a fuel cell vehicle and more specifically pertains to a vehicle equipped with fuel cells that generate electrical energy through an electrochemical reaction of a fuel gas and an oxidizing gas.

### BACKGROUND ART

Fuel cell vehicles are generally equipped with fuel cells that generate electrical energy through an electrochemical reaction of a fuel gas and an oxidizing gas. One proposed structure of the fuel cell vehicle is equipped with a battery as well as the fuel cells and controls a power demand required for the fuel cells during acceleration according to the state of charge of the battery. For example, a control technique proposed in Patent Document 1 does not set a significantly large value to the power demand for the fuel cells at a certain variation of the driver's depression amount of an accelerator pedal, when the battery has a sufficiently high state of charge and ensures sufficient power assist even in the case of a large acceleration demand. When the battery has a relatively low state of charge and does not ensure sufficient power assist even in the case of a small acceleration demand, on the other hand, the control technique sets a significantly large value to the power demand for the fuel cells at the same variation of the driver's depression amount of the accelerator pedal.

### Patent Document 1: Japanese Patent Laid-Open No. 2001-339810

### DISCLOSURE OF THE INVENTION

The control technique cited in Patent Document 1, however, determines the amount of battery assist only according to the magnitude of the driver's acceleration demand and the state of charge of the battery, while does not take account of any other factors for the determination. There may thus be problems of poor drivability or poor fuel economy according to the driving conditions.

An object of the present invention is to provide a fuel cell vehicle with improved drivability, compared with the prior art fuel cell vehicle. Another object of the present invention is to provide a fuel cell vehicle with improved fuel consumption, compared with the prior art fuel cell vehicle.

The present invention accomplishes at least part of the objects mentioned above by the following configurations applied to the fuel cell vehicle.

One aspect of the invention pertains to a first fuel cell vehicle including: a motor that is driven to rotate wheels; fuel cells that generate electrical energy through an electrochemical reaction of a fuel gas and an oxidizing gas; an accumulator that is charged with electrical energy and is discharged to output electrical energy; a drive mode detector that detects a drive mode set by a driver; a power demand setting module that is configured to set a power demand; a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the drive mode detected by the drive mode detector; and a controller that controls the fuel cells and the motor to enable a level of electrical energy actually output from the fuel cells to the motor and a level of electrical energy actually output from the accumulator to the motor to be consistent with the respective target values of electrical energy set by the target value setting module.

The fuel cell vehicle according to one aspect of the invention sets the target value of electrical energy to be output from the fuel cells to the motor and the target value of electrical energy to be output from the accumulator to the motor according to the set power demand, such that in response to the increase of the power demand, the target value of electrical energy to be output from the accumulator to the motor is set based on the drive mode. The fuel cell vehicle then controls the fuel cells and the motor to enable the level of electrical energy actually output from the fuel cells to the motor and the level of electrical energy actually output from the battery to the motor to be consistent with the respective target values of electrical energy. The fuel cell vehicle of this aspect adequately sets, in response to the increase of the power demand, the target value of electrical energy to be output from the accumulator to the motor according to the drive mode. This arrangement desirably improves the drivability and the fuel consumption, compared with the conventional structure of the fuel cell vehicle. The drive mode detector may be either a drive mode switch or a gearshift position sensor.

In one preferable application of the fuel cell vehicle according to the above aspect of the invention, the drive mode detector detects the driver's set drive mode among multiple different drive modes including at least a fuel consumption priority drive mode and an acceleration priority drive mode. The target value setting module sets, in response to the increase of the power demand, the target value of electrical energy to be output from the accumulator to the motor based on the drive mode detected by the drive mode detector, such that a greater value is set to the target value of electrical energy in the acceleration priority drive mode than the target value of electrical energy in the fuel consumption priority drive mode. This arrangement attains the improved drivability in response to the driver's preference to the acceleration over the fuel consumption or the improved fuel consumption in response to the driver's preference to the fuel consumption over the acceleration.

In one preferable embodiment of the invention, the fuel cell vehicle equipped with the drive mode detector further has an acceleration intention parameter specification module that specifies an acceleration intention parameter related to the driver's acceleration intention. The target value setting module sets, in response to the increase of the power demand, the target value of electrical energy to be output from the accumulator to the motor, based on both the drive mode detected by the drive mode detector and the acceleration intention parameter specified by the acceleration intention parameter specification module. This arrangement gives the driver the sufficient acceleration feeling or restricts the acceleration to improve the fuel consumption, in response to the driver's acceleration intention.

In another preferable embodiment of the invention, the fuel cell vehicle equipped with the drive mode detector further has a storage module that is configured to store a variation in target value of electrical energy to be output from the accumulator to the motor against the acceleration intention parameter related to the driver's acceleration intention, which is provided for each drive mode, in addition to the acceleration intention parameter specification module. The target value setting module sets, in response to the increase of the power demand, the target value of electrical energy to be output from the accumulator to the motor based on the drive mode detected by the drive mode detector, by reading out a corresponding variation provided for the drive mode detected by the drive mode detector from the storage module and referring to the corresponding variation to set the target value of electrical energy to be output from the accumulator to the motor corresponding to the acceleration intention parameter specified by the acceleration intention parameter specification module.

Another aspect of the invention pertains to a second fuel cell vehicle, including: a motor that is driven to rotate wheels; fuel cells that generate electrical energy through an electrochemical reaction of a fuel gas and an oxidizing gas; an accumulator that is charged with electrical energy and is discharged to output electrical energy; a vehicle speed detector that detects a vehicle speed; a power demand setting module that is configured to set a power demand; a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the vehicle speed detected by the vehicle speed detector; and a controller that controls the fuel cells and the motor to enable a level of electrical energy actually output from the fuel cells to the motor and a level of electrical energy actually output from the battery to the motor to be consistent with the respective target values of electrical energy set by the target value setting module.

The fuel cell vehicle according to another aspect of the invention sets the target value of electrical energy to be output from the fuel cells to the motor and the target value of electrical energy to be output from the accumulator to the motor according to the set power demand, such that in response to the increase of the power demand, the target value of electrical energy to be output from the accumulator to the motor is set based on the vehicle speed. The fuel cell vehicle then controls the fuel cells and the motor to enable the level of electrical energy actually output from the fuel cells to the motor and the level of electrical energy actually output from the battery to the motor to be consistent with the respective target values of electrical energy. The fuel cell vehicle of this aspect adequately sets, in response to the increase of the power demand, the target value of electrical energy to be output from the accumulator to the motor according to the vehicle speed. This arrangement desirably improves the drivability and the fuel consumption, compared with the conventional structure of the fuel cell vehicle. The vehicle speed detector may detect a rotation speed of the motor in a structure of direct linkage of an axle of the fuel cell vehicle with a rotating shaft of the motor.

In one preferable application of the fuel cell vehicle according to the above aspect of the invention, the target value setting module sets, in response to the increase of the power demand, the target value of electrical energy to be output from the accumulator to the motor based on the vehicle speed detected by the vehicle speed detector, such that a greater value is set to the target value of electrical energy in a high vehicle speed range than the target value of electrical energy in a low vehicle speed range. Such setting makes a torque of the accumulator applied to the motor in the high vehicle speed range substantially equivalent to the applied torque in the low vehicle speed range. This enables the driver to have the practically equivalent acceleration feeling irrespective of the vehicle speed and thus improves the drivability. The power applied to the motor is expressed by the product of the rotation speed and the torque of the motor. At a fixed power of the accumulator applied to the motor, a smaller torque is output in the high vehicle speed range with the higher rotation speed of the motor than the output torque in the low vehicle speed range with the lower rotation speed of the motor. The increased electrical energy output from the accumulator to the motor in the high vehicle speed range than the output electrical energy in the low vehicle speed range makes the torque of the accumulator applied to the motor in the high vehicle speed range substantially equivalent to the applied torque in the low vehicle speed range.

In one preferable embodiment of the invention, the fuel cell vehicle equipped with the vehicle speed detector further has an acceleration intention parameter specification module that specifies an acceleration intention parameter related to the driver's acceleration intention. The target value setting module sets, in response to the increase of the power demand, the target value of electrical energy to be output from the accumulator to the motor, based on both the vehicle speed detected by the vehicle speed detector and the acceleration intention parameter specified by the acceleration intention parameter specification module. This arrangement gives the driver the sufficient acceleration feeling or restricts the acceleration to improve the fuel consumption, in response to the driver's acceleration intention.

In another preferable embodiment of the invention, the fuel cell vehicle equipped with the vehicle speed detector further has a storage module that is configured to store a variation in target value of electrical energy to be output from the accumulator to the motor against the acceleration intention parameter related to the driver's acceleration intention, which is provided for each preset vehicle speed range, in addition to the acceleration intention parameter specification module. The target value setting module sets, in response to the increase of the power demand, the target value of electrical energy to be output from the accumulator to the motor based on the vehicle speed detected by the vehicle speed detector, by reading out a corresponding variation provided for a vehicle speed range of the vehicle speed detected by the vehicle speed detector from the storage module and referring to the corresponding variation to set the target value of electrical energy to be output from the accumulator to the motor corresponding to the acceleration intention parameter specified by the acceleration intention parameter specification module.

Still another aspect of the invention pertains to a third fuel cell vehicle, including: a motor that is driven to rotate wheels; fuel cells that generate electrical energy through an electrochemical reaction of a fuel gas and an oxidizing gas; an accumulator that is charged with electrical energy and is discharged to output electrical energy; a slope detector that detects an uphill slope of road surface; a power demand setting module that is configured to set a power demand; a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the uphill slope detected by the slope detector; and a controller that controls the fuel cells and the motor to enable a level of electrical energy actually output from the fuel cells to the motor and a level of electrical energy actually output from the battery to the motor to be consistent with the respective target values of electrical energy set by the target value setting module.

The fuel cell vehicle according to still another aspect of the invention sets the target value of electrical energy to be output from the fuel cells to the motor and the target value of electrical energy to be output from the accumulator to the motor according to the set power demand, such that in response to the increase of the power demand, the target value of electrical energy to be output from the accumulator to the motor is set based on the uphill slope. The fuel cell vehicle then controls the fuel cells and the motor to enable the level of electrical energy actually output from the fuel cells to the motor and the level of electrical energy actually output from the battery to the motor to be consistent with the respective target values of electrical energy. The fuel cell vehicle of this aspect adequately sets, in response to the increase of the power demand, the target value of electrical energy to be output from the accumulator to the motor according to the uphill slope. This arrangement desirably improves the drivability and the fuel consumption, compared with the conventional structure of the fuel cell vehicle.

In one preferable application of the fuel cell vehicle according to the above aspect of the invention, the target value setting module sets, in response to the increase of the power demand, the target value of electrical energy to be output from the accumulator to the motor based on the uphill slope detected by the slope detector, such that the target value of electrical energy increases with an increase in detected uphill slope. The higher uphill slope generally has the greater acceleration resistance than the lower uphill slope. The increased electrical energy output from the accumulator to the motor at the higher uphill slope than the output electrical energy at the lower uphill slope accordingly enables the driver to have the substantially equivalent acceleration feeling.

In one preferable embodiment of the invention, the fuel cell vehicle equipped with the slope detector further has an acceleration intention parameter specification module that specifies an acceleration intention parameter related to the driver's acceleration intention. The target value setting module sets, in response to the increase of the power demand, the target value of electrical energy to be output from the accumulator to the motor, based on both the uphill slope detected by the slope detector and the acceleration intention parameter specified by the acceleration intention parameter specification module. This arrangement gives the driver the sufficient acceleration feeling or restricts the acceleration to improve the fuel consumption, in response to the driver's acceleration intention.

In another preferable embodiment of the invention, the fuel cell vehicle equipped with the slope detector further has a storage module that is configured to store a variation in target value of electrical energy to be output from the accumulator to the motor against the acceleration intention parameter related to the driver's acceleration intention, which is provided for each preset uphill slope range, in addition to the acceleration intention parameter specification module. The target value setting module sets, in response to the increase of the power demand, the target value of electrical energy to be output from the accumulator to the motor based on the uphill slope detected by the slope detector, by reading out a corresponding variation provided for an uphill slope range of the uphill slope detected by the slope detector from the storage module and referring to the corresponding variation to set the target value of electrical energy to be output from the accumulator to the motor corresponding to the acceleration intention parameter specified by the acceleration intention parameter specification module.

According to another aspect, the invention is directed to a fourth fuel cell vehicle, including: a motor that is driven to rotate wheels; fuel cells that generate electrical energy through an electrochemical reaction of a fuel gas and an oxidizing gas; an accumulator that is charged with electrical energy and is discharged to output electrical energy; a friction coefficient detector that detects a road surface friction coefficient; a power demand setting module that is configured to set a power demand; a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the road surface friction coefficient detected by the friction coefficient detector; and a controller that controls the fuel cells and the motor to enable a level of electrical energy actually output from the fuel cells to the motor and a level of electrical energy actually output from the battery to the motor to be consistent with the respective target values of electrical energy set by the target value setting module.

The fuel cell vehicle according to another aspect of the invention sets the target value of electrical energy to be output from the fuel cells to the motor and the target value of electrical energy to be output from the accumulator to the motor according to the set power demand, such that in response to the increase of the power demand, the target value of electrical energy to be output from the accumulator to the motor is set based on the road surface friction coefficient. The fuel cell vehicle then controls the fuel cells and the motor to enable the level of electrical energy actually output from the fuel cells to the motor and the level of electrical energy actually output from the battery to the motor to be consistent with the respective target values of electrical energy. The fuel cell vehicle of this aspect adequately sets, in response to the increase of the power demand, the target value of electrical energy to be output from the accumulator to the motor according to the road surface friction coefficient. This arrangement desirably improves the drivability and the fuel consumption, compared with the conventional structure of the fuel cell vehicle.

In one preferable application of the fuel cell vehicle according to the above aspect of the invention, the target value setting module sets, in response to the increase of the power demand, the target value of electrical energy to be output from the accumulator to the motor based on the road surface friction coefficient detected by the friction coefficient detector, such that the target value of electrical energy decreases with a decrease in detected road surface friction coefficient. The road surface with the low road surface friction coefficient generally has higher slipping tendency than the road surface with the high road surface friction coefficient. The reduced electrical energy output from the accumulator to the motor desirably prevents abrupt application of a large torque and thereby enhances the drivability.

In one preferable embodiment of the invention, the fuel cell vehicle equipped with the friction coefficient detector further has an acceleration intention parameter specification module that specifies an acceleration intention parameter related to the driver's acceleration intention. The target value setting module sets, in response to the increase of the power demand, the target value of electrical energy to be output from the accumulator to the motor, based on both the road surface friction coefficient detected by the friction coefficient detector and the acceleration intention parameter specified by the acceleration intention parameter specification module. This arrangement gives the driver the sufficient acceleration feeling or restricts the acceleration to improve the fuel consumption on the normal road surface with low slipping tendency, while preventing the occurrence of slip on the road surface with high slipping tendency.

In another preferable embodiment of the invention, the fuel cell vehicle equipped with the friction coefficient detector further has a storage module that is configured to store a variation in target value of electrical energy to be output from the accumulator to the motor against the acceleration intention parameter related to the driver's acceleration intention, which is provided for each preset road surface friction coefficient range, in addition to the acceleration intention parameter specification module. The target value setting module sets, in response to the increase of the power demand, the target value of electrical energy to be output from the accumulator to the motor based on the road surface friction coefficient detected by the friction coefficient detector, by reading out a corresponding variation provided for a road surface friction coefficient range of the road surface friction coefficient detected by the friction coefficient detector from the storage module and referring to the corresponding variation to set the target value of electrical energy to be output from the accumulator to the motor corresponding to the acceleration intention parameter specified by the acceleration intention parameter specification module.

According to still another aspect, the invention is directed to a fifth fuel cell vehicle, including: a motor that is driven to rotate wheels; fuel cells that generate electrical energy through an electrochemical reaction of a fuel gas and an oxidizing gas; an accumulator that is charged with electrical energy and is discharged to output electrical energy; a power demand setting module that is configured to set a power demand; a target value setting module that is configured to set a target value of electrical energy to be output from the fuel cells to the motor and a target value of electrical energy to be output from the accumulator to the motor according to the set power demand, such that a greater value is set to the target value of electrical energy to be output from the accumulator to the motor in a state immediately after restart of operation of the fuel cells than the target value of electrical energy in an ordinary state; and a controller that controls the fuel cells and the motor to enable a level of electrical energy actually output from the fuel cells to the motor and a level of electrical energy actually output from the battery to the motor to be consistent with the respective target values of electrical energy set by the target value setting module.

The fuel cell vehicle according to still another aspect of the invention sets the target value of electrical energy to be output from the fuel cells to the motor and the target value of electrical energy to be output from the accumulator to the motor according to the set power demand, such that a greater value is set to the target value of electrical energy to be output from the accumulator to the motor in the state immediately after restart of operation of the fuel cells than the target value of electrical energy in the ordinary state. The fuel cell vehicle then controls the fuel cells and the motor to enable the level of electrical energy actually output from the fuel cells to the motor and the level of electrical energy actually output from the battery to the motor to be consistent with the respective target values of electrical energy. The fuel cells generally have a poorer response in the state immediately after restart of the operation, compared with a response in the ordinary state. The accumulator typically has the better response than the response of the fuel cells. The increased electrical energy output from the accumulator to the motor in the state immediately after the restart of operation of the fuel cells than the output electrical energy in the ordinary state effectively improves the overall power output response and prevents deterioration of the drivability.

In the fuel cell vehicle of this aspect, the state immediately after the restart of operation of the fuel cells may represent a state of immediately after a restart of the operation of the fuel cells upon satisfaction of a preset fuel cell operation restart condition, which follows a stop of the operation of the fuel cells upon satisfaction of a preset fuel cell operation stop condition.

In one preferable embodiment of the invention, the fuel cell vehicle further has an acceleration intention parameter specification module that specifies an acceleration intention parameter related to the driver's acceleration intention. The target value setting module sets the target value of electrical energy to be output from the fuel cells to the motor and the target value of electrical energy to be output from the accumulator to the motor according to the set power demand, such that the target value of electrical energy to be output from the accumulator to the motor is set in the ordinary state based on the acceleration intention parameter specified by the acceleration intention parameter specification module, and a greater value is set to the target value of electrical energy to be output from the accumulator to the motor in the state immediately after the restart of operation of the fuel cells than the target value of electrical energy in the ordinary state. This arrangement gives the driver the sufficient acceleration feeling or restricts the acceleration to improve the fuel consumption, in response to the driver's acceleration intention.

In another preferable embodiment of the invention, the fuel cell vehicle further has a storage module that is configured to store a variation in target value of electrical energy to be output from the accumulator to the motor against the acceleration intention parameter related to the driver's acceleration intention, which is provided separately for the ordinary state and for the state immediately after the restart of operation of the fuel cells, in addition to the acceleration intention parameter specification module. The target value setting module specifies a current operation state of the fuel cells, reads out a corresponding variation provided for the ordinary state or for the state immediately after the restart of operation of the fuel cells according to the specified current operation state of the fuel cells, and refers to the corresponding variation to set the target value of electrical energy to be output from the accumulator to the motor corresponding to the acceleration intention parameter specified by the acceleration intention parameter specification module.

In the fuel cell vehicle having any of the above configurations with the acceleration intention parameter specification module, for example, the acceleration intention parameter specification module may specify a change rate of an accelerator opening, which represents a time variation of the driver's depression amount of an accelerator pedal, as the acceleration intention parameter. In another example, the acceleration intention parameter specification module may specify a time variation of a drive power demand determined according to the driver's depression amount of the accelerator pedal, as the acceleration intention parameter.

### BRIEF DESCRIPTION OF THE DRAWINGS

FIG. 1 schematically illustrates the configuration of a fuel cell vehicle according to one embodiment of the invention;

FIG. 2 shows the schematic structure of a fuel cell;

FIG. 3 is a flowchart showing a drive control routine;

FIG. 4 shows one example of a torque demand setting map;

FIG. 5 is battery assist maps showing time variations of battery assist; FIG. 5(a) is a fuel consumption priority map, FIG. 5(b) is an ordinary map, and FIG. 5(c) is an acceleration priority map;

FIG. 6 is graphs showing fuel cell characteristic curves; FIG. 6(a) shows a P-I characteristic curve and FIG. 6(b) shows an I-V characteristic curve;

FIG. 7 is a graph showing a variation in total output power against time elapsed;

FIG. 8 is graphs showing variations in total output power against time elapsed; FIG. 8(a) is a graph in a mode position MP set to an economic mode, FIG. 8(b) is a graph in the mode position MP set to an ordinary mode, and FIG. 8(c) is a graph in the mode position MP set to a sports mode;

FIG. 9 is a battery assist map designed to give a greater time variation of assist amount at a higher vehicle speed;

FIG. 10 is battery assist maps; FIG. 10(a) is a small slope area map, FIG. 10(b) is a moderate slope area map, and FIG. 10(c) is a large slope area map;

FIG. 11 is battery assist maps; FIG. 11(a) is a low broad surface map and FIG. 11(b) is a normal road surface map;

FIG. 12 is a flowchart showing one modified flow of the drive control routine; and

FIG. 13 is battery assist maps; FIG. 13(a) is an ordinary FC operation map and FIG. 13(b) is a lowered FC response map.

### BEST MODES OF CARRYING OUT THE INVENTION

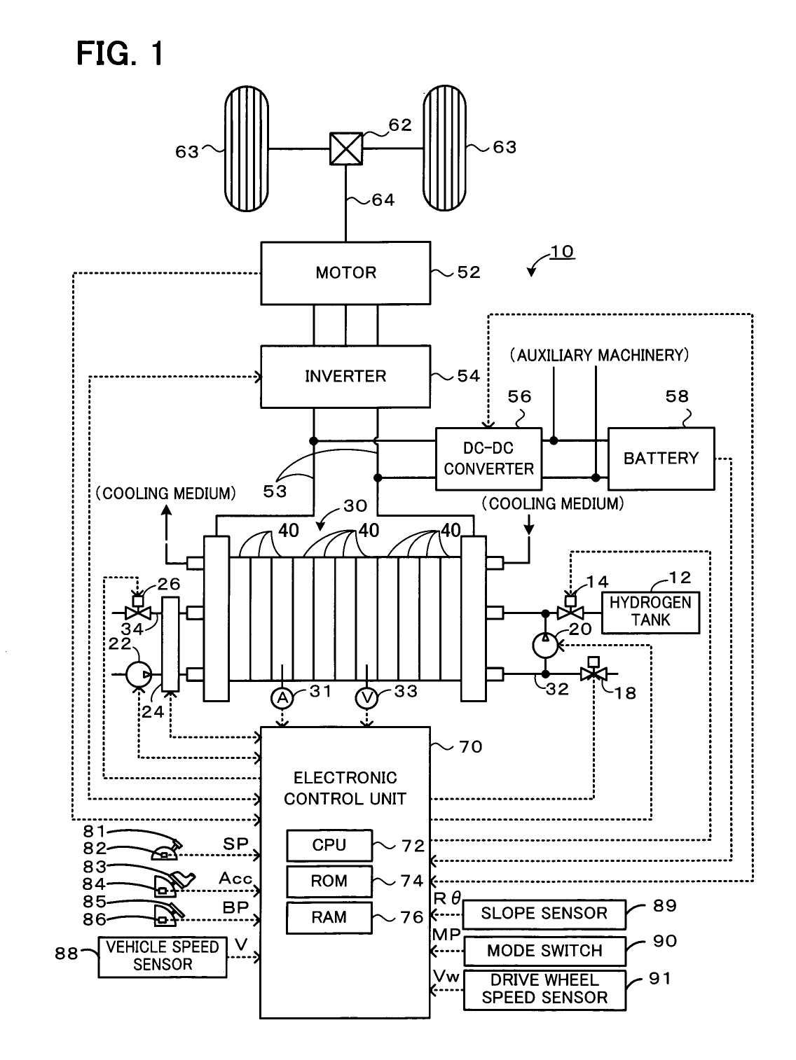

One mode of carrying out the invention is described below with reference to the accompanied drawings. FIG. 1 schematically illustrates the configuration of a fuel cell vehicle 10 according to one embodiment of the invention.

The fuel cell vehicle 10 includes a fuel cell stack 30 obtained by lamination of multiple fuel cells 40 that generate electric power through electrochemical reaction of hydrogen as a fuel gas and oxygen included in the air as an oxidizing gas. The fuel cell vehicle 10 also includes a motor 52 that is connected to the fuel cell stack 30 via an inverter 54, a battery 58 that is connected via a DC-DC converter 56 to power lines 53 for connecting the fuel cell stack 30 with the inverter 54, and an electronic control unit 70 that controls the operations of the whole fuel cell vehicle 10. A driveshaft 64 is linked to drive wheels 63,63 via a differential gear 62, so that power generated by the motor 52 is transmitted through the driveshaft 64 and is eventually output to the drive wheels 63, 63.

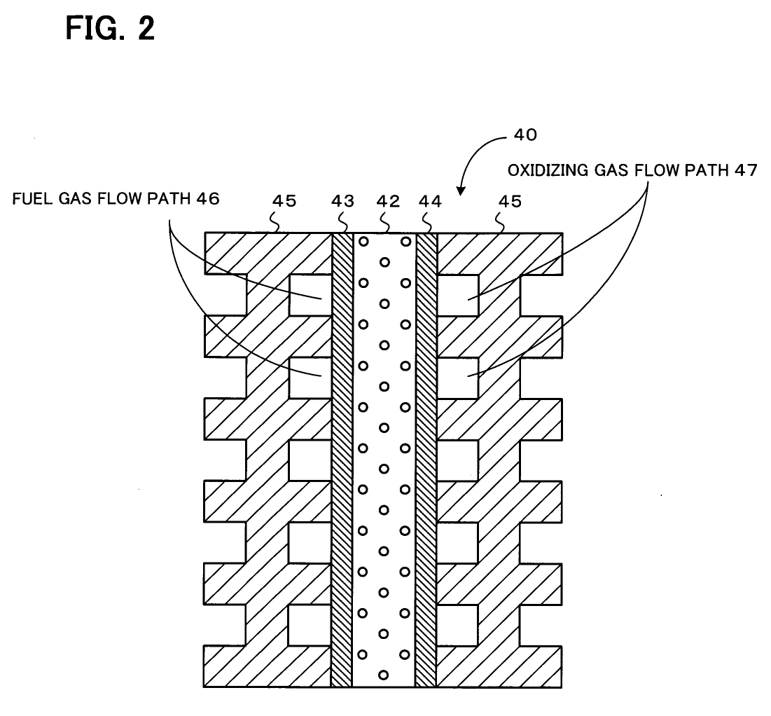

The fuel cell stack 30 is obtained by laminating a number of (for example, several hundred) polymer electrolyte fuel cells 40. FIG. 2 shows the schematic structure of the fuel cell 40. As illustrated, the fuel cell 40 has a proton-conductive solid electrolyte membrane 42 that is made of a polymer material, such as a fluororesin, and an anode 43 and a cathode 44 as gas diffusion electrodes that are made of carbon cloth with either a platinum catalyst or a platinum alloy catalyst applied thereon and are placed across the solid electrolyte membrane 42 with the respective catalyst-applying faces in contact with the solid electrolyte membrane 42 to form a sandwich-like structure. The fuel cell 40 also has two separators 45 that are placed across the sandwich-like structure and form, in combination with the anode 43, a fuel gas flow path 46 and, in combination with the cathode 44, an oxidizing gas flow path 47 while working as partition walls of respective adjacent fuel cells 40. The hydrogen gas flowing through the fuel gas flow path 46 is diffused on the anode 43 and is divided into proton and electron by the function of the catalyst. The proton is transmitted through the solid electrolyte membrane 42 kept in the wet state to the cathode 44, while the electron runs through an external circuit and reaches the cathode 44. Oxygen in the air flowing through the oxidizing gas flow path 47 is diffused on the cathode 44 and is made to react with the proton and the electron on the catalyst to produce water. Through this electrochemical reaction, each fuel cell 40 has an electromotive force and generates electrical energy. An ammeter 31 and a voltmeter 33 are attached to the fuel cell stack 30. The ammeter 31 detects the electric current output from the fuel cell stack 30, while the voltmeter 33 detects the voltage output from the fuel cell stack 30.

The fuel cell stack 30 is equipped with a hydrogen tank 12 for supply of hydrogen and an air compressor 22 for pressure-feed of the air supply. The hydrogen tank 12 has storage of high-pressure hydrogen of several-ten MPa. The high-pressure hydrogen gas is subjected to pressure regulation by a regulator 14 and is fed to the fuel cell stack 30. The hydrogen gas supplied to the fuel cell stack 30 flows through the fuel gas flow paths 46 of the respective fuel cells 40 (see FIG. 2) and is led to a fuel gas exhaust conduit 32. The fuel gas exhaust conduit 32 is equipped with an anode purge valve 18 to increase the hydrogen concentration in the fuel cell stack 30. The concentration of hydrogen in the fuel gas flow paths 46 (see FIG. 2) is lowered by transmission of nitrogen in the air from the oxidizing gas flow paths 47 into the anode 43. The anode purge valve 18 is accordingly opened for a predetermined opening time at preset intervals to drive out nitrogen from the fuel gas flow paths 46. A hydrogen circulation pump 20 is driven to introduce a hydrogen-containing gas present in a location between the fuel cell stack 30 and the anode purge valve 18 in the fuel gas exhaust conduit 32 into a location between the fuel cell stack 30 and the regulator 14 in the fuel gas exhaust conduit 32. The feed rate of hydrogen is regulated by varying the rotation speed of the hydrogen circulation pump 20.

The air compressor 22 works to pressure-feed the intake air, which is taken in from the atmosphere via an air cleaner (not shown), to the fuel cell stack 30. The feed rate of oxygen is regulated by varying the rotation speed of the air compressor 22. A humidifier 24 is provided between the air compressor 22 and the fuel cell stack 30. The humidifier 24 humidifies the air pressure-fed by the air compressor 22 and supplies the humidified air to the fuel cell stack 30. The air supplied to the fuel cell stack 30 flows through the oxidizing gas flow paths 47 of the respective fuel cells 40 (see FIG. 2) and is discharged into an oxidizing gas exhaust conduit 34. The oxidizing gas exhaust conduit 34 is equipped with an air pressure regulator 26 to adjust the pressure in the oxidizing gas flow paths 47. The air discharged from the fuel cell stack 30 into the oxidizing gas exhaust conduit 34 is humid with the water produced by the electrochemical reaction. The humidifier 24 transfers the moisture from the discharged humid air to the pressure-fed air supply.

Auxiliary machinery shown in FIG. 1 include, for example, the regulator 14, the humidifier 24, the anode purge valve 18, the hydrogen circulation pump 20, the air compressor 22, and the air pressure regulator 26 and receive a supply of electric power from either the fuel cell stack 30 or the battery 58.

The motor 52 is linked with the driveshaft 64 and is constructed as a known synchronous motor generator working as both a generator and a motor. The motor 52 transmits electric power to and from the battery 58 and the fuel cell stack 30 via the inverter 54.

The battery 58 may be a known nickel metal hydride battery or lithium ion secondary battery and is connected in series with the fuel cell stack 30 via the DC-DC converter 56. The battery 58 accumulates the regenerative energy generated by deceleration of the fuel cell vehicle 10 and the electrical energy generated by the fuel cell stack 30, while discharging the accumulated electrical energy to supplement the insufficiency of electric power generated by the fuel cell stack 30 according to a power demand of the motor 52. The latter operation supplies the electric power to the motor 52 to compensate for the insufficient electric power generated by the fuel cell stack 30. This operation is thus hereafter referred to as assist of the battery 58 for the fuel cell stack 30 or simply as battery assist. The battery 58 may be replaced by a capacitor.

The electronic control unit 70 is constructed as a one-chip microprocessor including a CPU 72, a ROM 74 that stores processing programs, a RAM 76 that temporarily stores data, and input and output ports (not shown). The electronic control unit 70 receives, via its input port, an output current Ifc and an output voltage Vfc of the fuel cell stack 30 respectively measured by the ammeter 31 and the voltmeter 33, signals representing the flow rates and the temperatures of the hydrogen supply and the air supply to the fuel cell stack 30 measured by flowmeters and thermometers (not shown), signals regarding the operating conditions of the humidifier 24 and the air compressor 22, signals required for controlling the operation of the motor 52 (for example, a rotation speed Nm of the motor 52 and phase currents to be applied to the motor 52), and a charge-discharge current required for controlling and managing the operation of the battery 58. The electronic control unit 70 calculates a current state of charge (SOC) of the battery 58 from an integrated value of the charge-discharge current of the battery 58, while calculating an output power Pfc of the fuel cell stack 30 from the output current Ifc and the output voltage Vfc of the fuel cell stack 30. The electronic control unit 70 also receives, via its input port, a vehicle speed V from a vehicle speed sensor 88, a gearshift position SP or a current setting position of a gearshift lever 81 from a gearshift position sensor 82, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, a road slope RO or the gradient of the road surface from a slope sensor 89, a mode position MP set by the driver from a drive mode switch 90, and drive wheel speeds Vw from drive wheel speed sensors 91 attached to the drive wheels 63,63. In the structure of this embodiment, the setting of the drive mode switch 90 is selectable by the driver among three options, that is, an economic mode giving priority to fuel consumption, a sports mode giving priority to acceleration, and an intermediate ordinary mode in between the two preceding modes. The electronic control unit 70 outputs, via its output port, various control signals and driving signals, for example, driving signals to the air compressor 22, control signals to the humidifier 16, control signals to the regulator 14, the anode purge valve 18, and the air pressure regulator 26, control signals to the inverter 54, and control signals to the DC-DC converter 56.

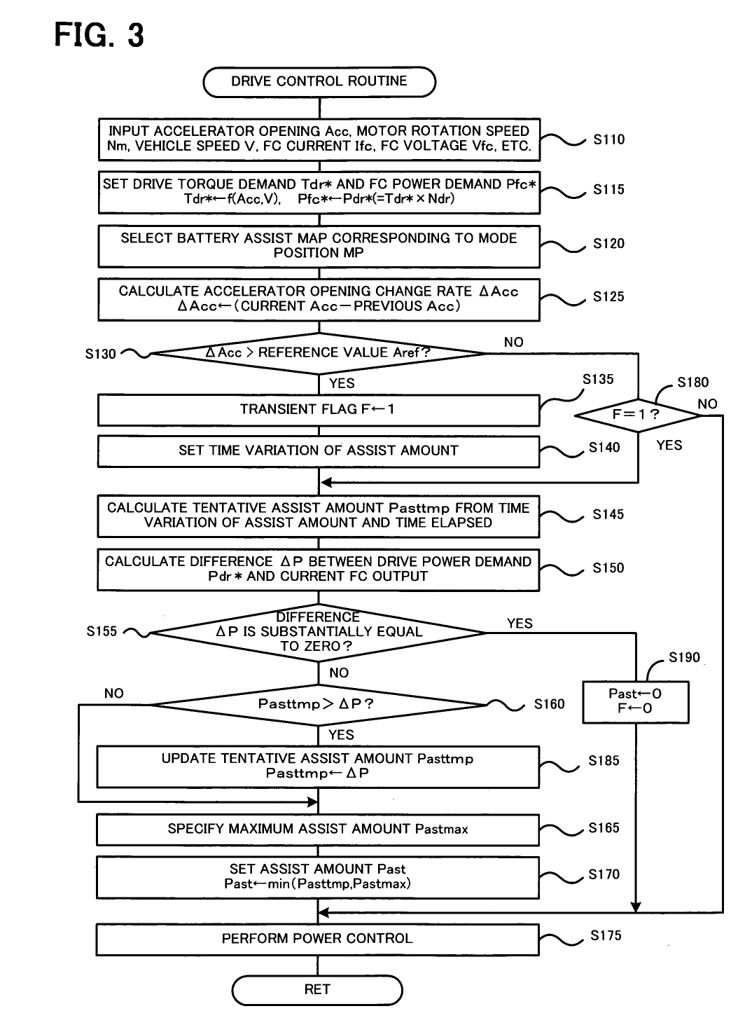

The description regards series of operations performed in the fuel cell vehicle 10 of the embodiment constructed as described above. FIG. 3 is a flowchart showing a drive control routine, which is repeatedly executed at preset time intervals (for example, at every 8 msec) by the electronic control unit 70 while the fuel cell vehicle 10 is driven with power generation of the fuel cell stack 30. For the simplicity of explanation, it is here assumed that a drive power demand Pdr* is coverable by the output power Pfc of the fuel cell stack 30 alone and that the state of charge SOC of the battery 58 is in an adequate charge range with no requirement for charging.

On the start of the drive control routine, the CPU 72 of the electronic control unit 70 first inputs various data required for control, that is, the accelerator opening Acc from the accelerator pedal position sensor 84, the vehicle speed V from the vehicle speed sensor 88, the rotation speed Nm of the motor 52, the output current Ifc of the fuel cell stack 30 from the ammeter 31, the output voltage Vfc of the fuel cell stack 30 from the voltmeter 33, the mode position MP from the mode switch 90, and the charge-discharge current of the battery 58 (step S110).

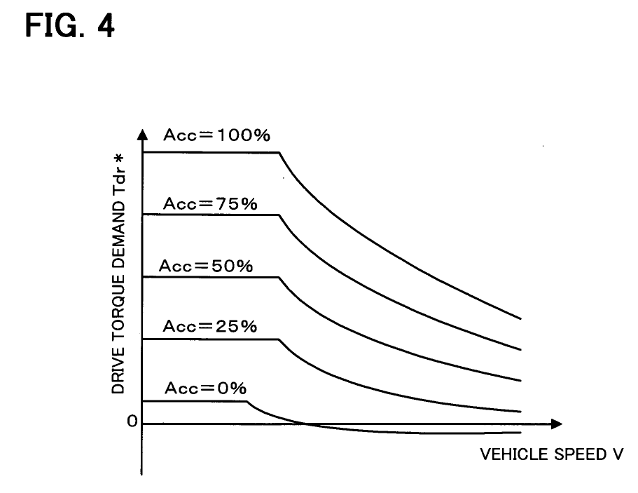

After the data input, the CPU 72 sets a drive torque demand Tdr* to be output to the driveshaft 64 linked with the drive wheels 63,63 as a torque required for the fuel cell vehicle 10 and an FC power demand Pfc* required for the fuel cell stack 30, based on the input accelerator opening Acc and the input vehicle speed V (step S115). A concrete procedure of setting the drive torque demand Tdr* in this embodiment stores in advance variations in drive torque demand Tdr* against the accelerator opening Acc and the vehicle speed V as a torque demand setting map in the ROM 74 and reads the drive torque demand Tdr* corresponding to the given accelerator opening Acc and the given vehicle speed V from this torque demand setting map. One example of the torque demand setting map is shown in FIG. 4. The FC power demand Pfc* is given as the sum of the product of the set drive power demand Tdr* and a rotation speed Ndr of the driveshaft 64 (this is equal to the drive power demand Pdr*) and a charge-discharge power demand Pb* to be charged into or discharged from the battery 58. As mentioned previously, it is assumed that the drive power demand Pdr* is coverable by the output power Pfc of the fuel cell stack 30 alone and that the state of charge SOC of the battery 58 is in the adequate charge range with no requirement for charging. On such assumptions, the FC power demand Pfc* is equal to the drive power demand Pdr*. In the structure of this embodiment, since a rotating shaft of the motor 52 is directly linked with the driveshaft 64, the rotation speed Ndr of the driveshaft 64 is identical with the rotation speed Nm of the motor 52.

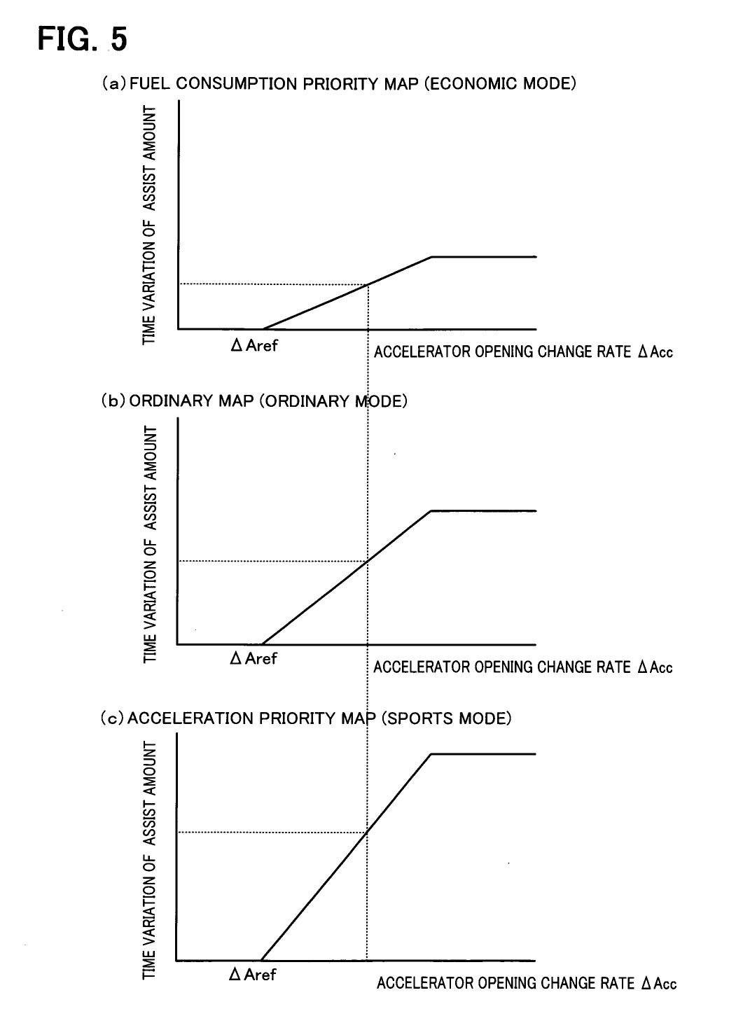

The CPU 72 subsequently selects an adequate battery assist map corresponding to the mode position MP input from the drive mode switch 90 (step S120). The battery assist map represents a time variation of assist amount against a rate of change in accelerator opening ΔAcc (accelerator opening change rate) as shown in FIG. 5. Three battery assist maps are provided for the respective modes, the economic mode, the ordinary mode, and the sports mode, and are stored in the ROM 74. The accelerator opening change rate ΔAcc is a difference between a current accelerator opening Acc input at step S110 in a current cycle of the drive control routine and a previous accelerator opening Acc input at step S110 in a previous cycle of the drive control routine. The accelerator opening change rate ΔAcc is used as a parameter for estimating the driver's intention of accelerator requirement. A large value of the accelerator opening change rate ΔAcc means an abrupt depression of the accelerator pedal 83 to a large depth. In this case, the driver's requirement for abrupt acceleration is inferred. A small value of the accelerator opening change rate ΔAcc, on the other hand, means a mild depression of the accelerator pedal 83. In this case, the driver's requirement for moderate acceleration is inferred. Multiplication of the time variation of assist amount by a time elapsed since a start of the battery assist gives an assist amount Past of the battery 58. Each of the battery assist maps is designed to keep the time variation of assist amount equal to zero at the accelerator opening change rate ΔAcc of not higher than a predetermined reference value Aref and to increase the time variation of assist amount with an increase in accelerator opening change rate ΔAcc that is higher than the predetermined reference value Aref. The increase in time variation of assist amount has the gentler slope in the order of the fuel consumption priority map, the ordinary map, and the accelerator priority map. In each of the battery assist maps, the time variation of assist amount reaches its maximum ‘t’ at the accelerator opening change rate ΔAcc of not smaller than a specific value. The battery assist map selected at step S120 is the fuel consumption priority map corresponding to the economic mode as the input mode position MP, the ordinary map corresponding to the ordinary mode, and the acceleration priority map corresponding to the sports mode.

The CPU 72 subsequently calculates the accelerator opening change rate ΔAcc (step S125). It is then determined whether the calculated accelerator opening change rate ΔAcc exceeds the predetermined reference value Aref (step S130). The reference value Aref represents a criterion for identifying the driver's requirement for moderate acceleration or the driver's requirement for abrupt acceleration and is obtained as a result of the repeated experiments. The reference value Aref is set to significantly reduce or substantially eliminate a difference between a time required for coverage of an increased amount of the drive power demand Pdr* at the accelerator opening change rate ΔAcc equal to the reference value Aref and a time required for the driver's demanded acceleration.

Immediately after the driver's requirement for abrupt acceleration in the steady driving state, the accelerator opening change rate ΔAcc exceeds the predetermined reference value Aref. In this case, a transient state flag F is set equal to 1 (step S135) The transient state flag F is set to 1 in a transient state of the fuel cell stack 30, while being reset to 0 in a non-transient state of the fuel cell stack 30. In the transient state, the output power Pfc of the fuel cell stack 30 keeps increasing to the drive power demand Pdr*. The fuel cell stack 30 generates the output power Pfc through the electrochemical reaction, so that a certain time period is required before actual output of the drive power demand Pdr* set in response to the driver's requirement for abrupt acceleration. This causes the transient state. The CPU 72 subsequently refers to the battery assist map selected at step S120 to determine the time variation of assist amount corresponding to the calculated accelerator opening change rate ΔAcc (step S140), and calculates a tentative assist amount Pasttmp by multiplying the determined time variation of assist amount by a time elapsed since the time point when the accelerator opening change rate ΔAcc exceeds the predetermined reference value Aref (step S145). The CPU 72 also calculates a difference ΔP between the drive power demand Pdr* and the current output power Pfc of the fuel cell stack 30 (step S150) and determines whether the calculated difference ΔP is substantially equal to zero (step S155). Immediately after the driver's requirement for abrupt acceleration in the steady driving state, it is determined that the difference ΔP is substantially not equal to zero. The CPU 72 subsequently determines whether the tentative assist amount Pasttmp calculated at step S150 is greater than the calculated difference ΔP (step S160). Immediately after the driver's requirement for abrupt acceleration in the steady driving state, the difference ΔP has a significantly large value, so that the tentative assist amount Pasttmp is not greater than the difference ΔP. This leads to a negative answer at step S160. The CPU 72 then specifies a maximum assist amount Pastmax as an upper allowable limit of battery assist in the current state according to the state of charge SOC and the temperature of the battery 58 (step S165). The smaller between the tentative assist amount Pasttmp and the maximum assist amount Pastmax is set to an assist amount Past (step S170). The CPU 72 subsequently performs power control of the fuel cell stack 30 and the battery 58 (step S175). A concrete procedure of power control regulates the rotation speed of the air compressor 22 to increase or decrease the flow rate of the air and thereby ensure output of the FC power demand Pfc* (=drive power demand Pdr*) from the fuel cell stack 30, and simultaneously drives the DC-DC converter 56 to regulate an operation point of the fuel cell stack 30. The hydrogen gas from the hydrogen tank 12 goes through the regulator 14 and is fed to the fuel cell stack 30. An unconsumed remaining portion of the hydrogen supply is discharged into the fuel gas exhaust conduit 32 and is recirculated by the hydrogen circulation pump 20 to be returned to the fuel cell stack 30, whereas a consumed portion of the hydrogen supply is covered by a new supply of hydrogen from the hydrogen tank 12. The assist amount Past is supplied to the motor 52 via the DC-DC converter 56 and the inverter 54.

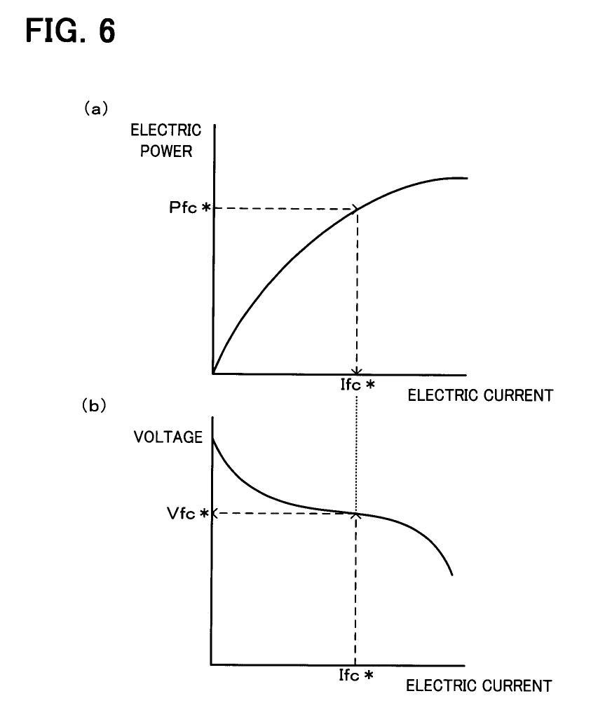

A concrete procedure of regulating the operation point of the fuel cell stack 30 refers to an electric power−electric current characteristic curve (P-I characteristic curve) shown in FIG. 6(a) to specify an electric current Ifc* required for output of the determined FC power demand Pfc*, while referring to an electric current−voltage characteristic curve (I-V characteristic curve) shown in FIG. 6(b) to specify a voltage Vfc* corresponding to the specified electric current Ifc*. The concrete procedure then sets the specified voltage Vfc* to a target voltage and regulates the output voltage of the fuel cell stack 30 via the DC-DC converter 56. This series of operations regulates the operation point and controls the resulting output power Pfc of the fuel cell stack 30. The P-I characteristic curve and the I-V characteristic curve are corrected at regular intervals to compensate for their changes due to a temperature variation or a variation of any other relevant factor. During repetition of the processing of steps S110 to S175, the driver's depression of the accelerator pedal 83 is made stable and it is eventually determined at step S130 that the accelerator opening change rate ΔAcc is not higher than the predetermined reference value Aref. The CPU 72 of the electronic control unit 70 then determines whether the transient state flag F is equal to 1 (step S180). When the accelerator opening change rate ΔAcc is lowered from the level over the predetermined reference value Aref and reaches to or below the predetermined reference value Aref for the first time, the transient state flag F is equal to 1. An affirmative answer is thus given at step S180. The control flow then executes the processing of steps S145 to S170 to set the assist amount Past and performs the power control of the fuel cell stack 30 and the battery 58 at step S175. At the accelerator opening change rate ΔAcc lowered to or below the predetermined reference value Aref, the assist of the battery 58 for the fuel cell stack 30 is controlled to make the sum of the output power Pb of the battery 58 and the output power Pfc of the fuel cell stack 30 sufficiently approach to the drive power demand Pdr*.

During repetition of the processing of steps S110 to S130, S180, and S145 to S175, it may be determined at step S160 that the tentative assist amount Pasttmp is greater than the difference ΔP. In this case, the CPU 72 updates the tentative assist amount Pasttmp to the value of the difference ΔP (step S185). Such updating of the tentative assist amount Pasttmp to the value of the difference ΔP is required because the sum of the output power Pb of the battery 58 and the output power Pfc of the fuel cell stack 30 exceeds the drive power demand Pdr* at the assist amount Past over the difference ΔP. The control flow then executes the processing of steps S165 and S170 to set the assist amount Past and performs the power control of the fuel cell stack 30 and the battery 58 at step S175. Such control desirably prevents the sum of the output power Pb of the battery 58 and the output power Pfc of the fuel cell stack 30 from exceeding the drive power demand Pdr*.

During repetition of the processing of steps S110 to S130, S180, S145 to S160, S185, and S165 to S175, it may be determined at step S155 that the difference ΔP is substantially equal to 0. In this case, the CPU 72 sets the assist amount Past to zero and resets the transient state flag F to 0 (step S190). The difference ΔP substantially equal to zero means that the drive power demand Pdr* is practically coverable by the output power Pfc of the fuel cell stack 30 alone. The assist amount Past is thus set to zero to terminate the assist of the battery 58. The subsequent power control of the fuel cell stack 30 executed at step S175 enables the fuel cell stack 30 to output the drive power demand Pdr* to the motor 58.

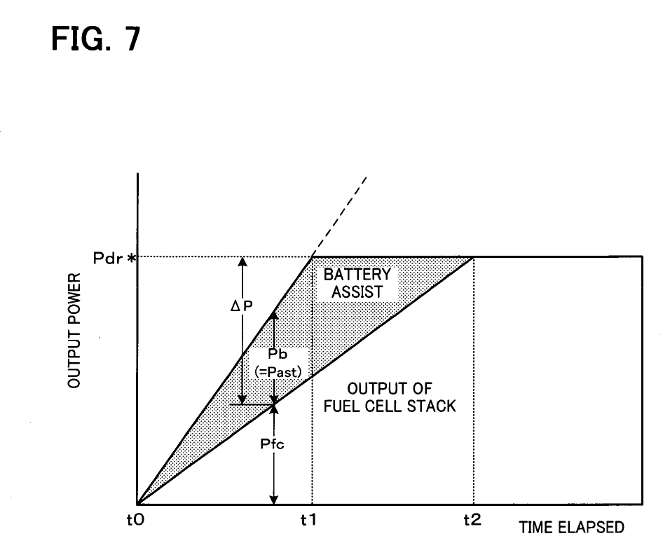

The following describes a variation in sum of the output power Pb of the battery 58 and the output power Pfc of the fuel cell stack 30 in the course of execution of the drive control routine with reference to the graph of FIG. 7. The graph of FIG. 7 shows a variation in sum of the output power Pb of the battery 58 and the output power Pfc of the fuel cell stack 30 against a time elapsed since a time point t0 when the accelerator opening change rate ΔAcc exceeds the predetermined reference value Aref. For the simplicity of explanation, it is here assumed that the tentative assist amount Pasttmp is not greater than the maximum assist amount Pastmax and that the assist amount Past is equal to the tentative assist amount Pasttmp. In the graph of FIG. 7, at a time point t1, the tentative assist amount Pasttmp becomes equal to the difference ΔP. At a time point t2, the difference ΔP decreases to substantially zero. The assist amount Past, which is given by multiplying the time variation of assist amount by the time elapsed, gradually increases with elapse of time during a time period between the time point t0 and the time point t1. During a time period between the time point t1 and the time point t2, the assist amount Past reaches the difference ΔP, so that the sum of the output power Pb of the battery 58 and the output power Pfc of the fuel cell stack 30 is consistent with the drive power demand Pdr*. After the time point t2, the difference ΔP is kept substantially equal to zero. There is accordingly no assist of the battery 58, but the drive power demand Pdr* is covered by the output power Pfc of the fuel cell stack 30 alone. If there is no assist of the battery 58 over the whole time period and only the output power Pfc of the fuel cell stack 30 is usable, the drive power demand Pdr* is not satisfied until the time point t2. The assist of the battery 58 as described above, however, enables the drive power demand Pdr* to be satisfied at the time point t1.

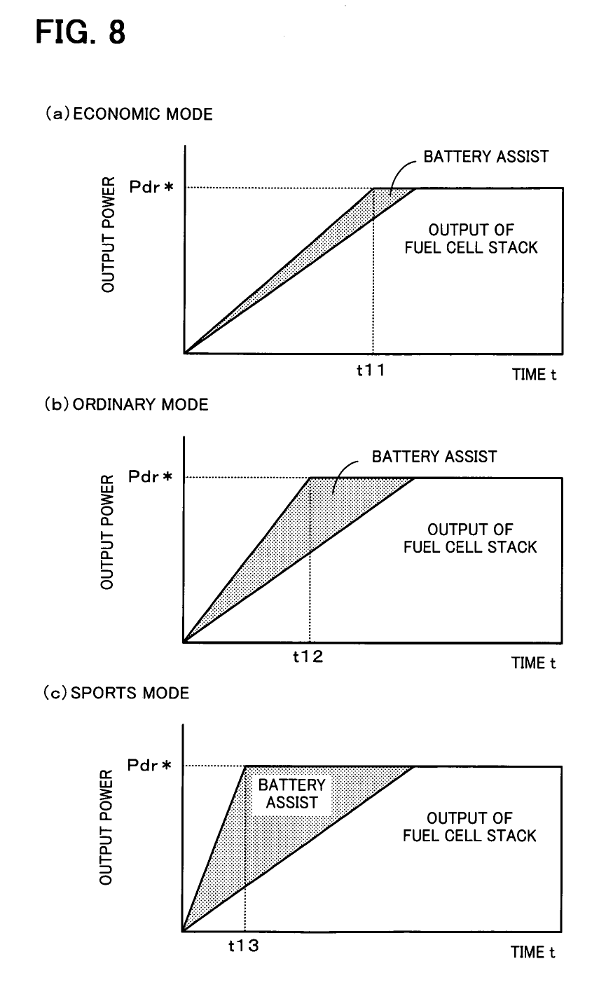

Like the graph of FIG. 7, graphs of FIG. 8 show variations in sum of the output power Pb of the battery 58 and the output power Pfc of the fuel cell stack 30 against the time elapsed since the time point t0 when the accelerator opening change rate ΔAcc exceeds the predetermined reference value Aref. FIG. 8(a) shows the variation of the output power at the mode position MP set to the economic mode. FIG. 8(b) shows the variation of the output power at the mode position MP set to the ordinary mode. FIG. 8(c) shows the variation of the output power at the mode position MP set to the sports mode. As clearly understood by the comparison of these graphs, the amount of battery assist is reduced in the order of the sports mode, the ordinary mode, and the economic mode. The total output power accordingly reaches the drive power demand Pdr* at an earliest time point t13 for the sports mode, at an intermediate time point t12 for the ordinary mode, and at a latest time point t11 for the economic mode. Namely the response to the driver's operation for acceleration is good for the sports mode, moderate for the ordinary mode, and poor for the economic mode. The fuel economy during acceleration is, on the contrary, good for the economic mode, moderate for the ordinary mode, and poor for the sports mode, since a decrease in charge-discharge efficiency of the DC-DC converter 56 located between the battery 58 and the inverter 54 has the greater adverse effects on the fuel consumption with an increase in amount of battery assist.

As described above, the fuel cell vehicle 10 of the embodiment sets the assist amount of the battery 58 (time variation of assist amount×time elapsed) according to the mode position MP and the accelerator opening change rate ΔAcc. Such setting desirably improves the drivability and the fuel consumption. The driver's requirement for abrupt acceleration is inferred from the large value of the accelerator opening change rate ΔAcc. In this case, the assist amount is increased to give the sufficient acceleration feeling to the driver. The driver's requirement for moderate acceleration is inferred, on the other hand, from the small value of the accelerator opening change rate ΔAcc. In this case, the assist amount is reduced to restrict the acceleration and improve the fuel consumption. The setting of the mode position MP to the sports mode suggests the driver's preference to the acceleration over the fuel consumption. The assist amount is thus increased to ensure the sufficient acceleration feeling. The setting of the mode position MP to the economic mode, on the other hand, suggests the driver's preference to the fuel consumption over the acceleration. The assist amount is thus reduced to improve the fuel consumption.

The embodiment discussed above is to be considered in all aspects as illustrative and not restrictive. There may be many modifications, changes, and alterations without departing from the scope or spirit of the main characteristics of the present invention.

For example, in the structure of the embodiment, there are three different modes, the sports mode, the ordinary mode, and the economic mode, selectable by the drive mode switch 90. These three modes are, however, not restrictive, but any other suitable modes may be added according to the requirements, for example, a snow mode having a smaller assist amount than the other modes to prevent an abrupt torque increase. The drive control may not perform the battery assist in the economic mode.

In the structure of the embodiment, the same reference value Aref is adopted for all the modes. The reference value Aref may, however, be decreased in the order of the fuel consumption priority map in the economic mode, the ordinary map in the ordinary mode, and the acceleration priority mode in the sports mode. This varies the frequency of battery assist to have the highest frequency in the sports mode and the lowest frequency in the economic mode and thus further improves the fuel consumption in the economic mode.

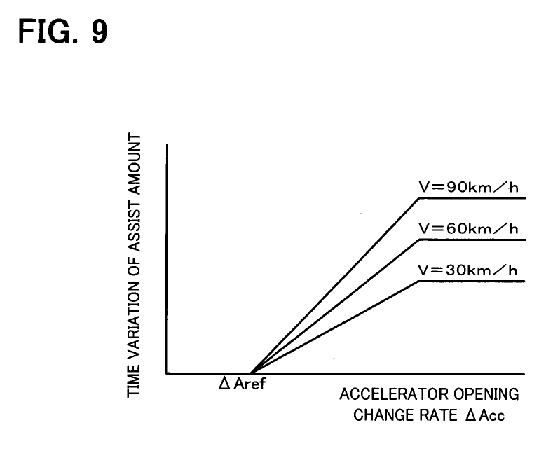

The drive control of the above embodiment calculates the amount of battery assist, irrespective of the vehicle speed. One possible modification may calculate the amount of battery assist by taking into account the vehicle speed. As shown in FIG. 9, the time variation of assist amount may be set to increase with an increase in vehicle speed. Such setting makes the level of assist torque of the battery 58 applied to the motor 52 at the higher vehicle speed substantially equivalent to the level of assist torque at the lower vehicle speed. This enables the driver to have the practically equivalent acceleration feeling irrespective of the vehicle speed and thus improves the drivability. The power applied to the motor 52 is expressed by the product of the rotation speed and the torque of the motor 52. At a fixed assist amount (power), a smaller torque is output at the higher vehicle speed with the higher rotation speed of the motor 52 than an output torque at the lower vehicle speed with the lower rotation speed of the motor 52. The increased assist amount at the higher vehicle speed than the assist amount at the lower vehicle speed makes the level of assist torque at the higher vehicle speed substantially equivalent to the level of assist torque at the lower vehicle speed. In the structure of the embodiment, the driveshaft 64 is directly linked with the rotating shaft of the motor 52 as mentioned previously. The vehicle speed V may thus be replaced by the rotation speed Nm of the motor 52.

In the structure of the embodiment, the drive control routine of FIG. 3 selects the adequate battery assist map corresponding to the mode position MP input from the drive mode switch 90 at step S120. This application is, however, not essential but may be replaced by any of modified applications (1) through (3) described below for selection of an adequate battery assist map.

(1) In one modified application, the driver is allowed to select a desired gearshift position of the gearshift lever 81 among a gearshift position for the sports mode, a gearshift position for the ordinary mode, and a gearshift position for the economic mode. In a corresponding modified flow of the drive control routine of FIG. 3, the adequate battery assist map is selected corresponding to the gearshift position SP input from the gearshift position sensor 82 at step S120. This modified application exerts the same effects as those of the embodiment described above.

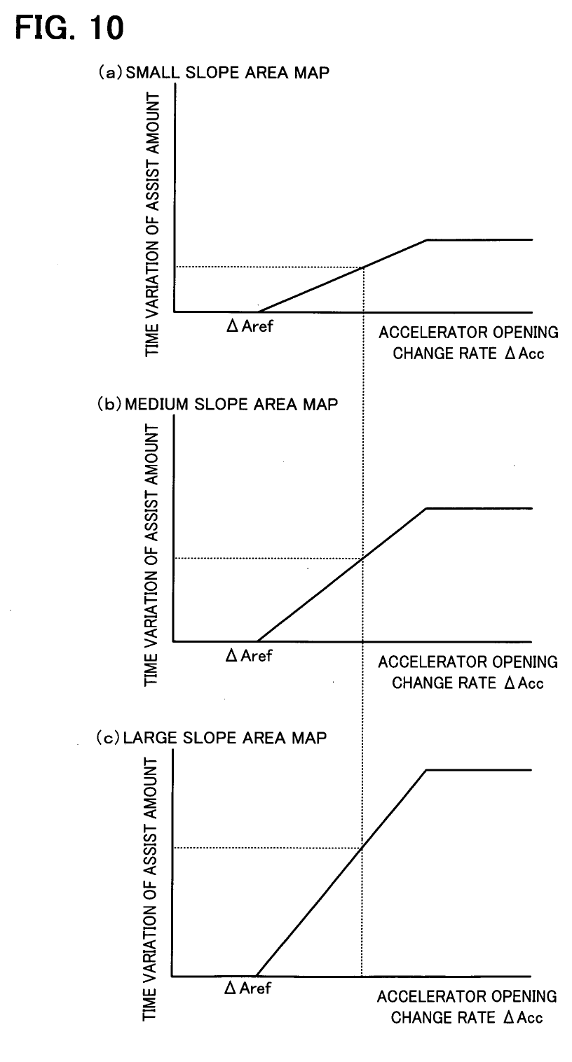

(2) Another modified application divides a range of an uphill slope RO into a small slope area, a medium slope area, and a large slope area. As shown in FIGS. 10(a) through 10(c), the battery assist map for the economic mode is used as a small slope area map. The battery assist map for the ordinary mode is used as a medium slope area map. The battery assist map for the sports mode is used as a large slope area map. In a corresponding modified flow of the drive control routine of FIG. 3, the adequate battery assist map is selected corresponding to the uphill slope RO input from the slope sensor 89 at step S120. This modified application ensures the adequate setting of the amount of battery assist according to the uphill slope RO and thereby improves the drivability and the fuel consumption. The higher uphill slope RO generally has the greater acceleration resistance than the lower uphill slope RO. The increased assist amount at the higher uphill slope RO than the assist amount at the lower uphill slope RO accordingly enables the driver to have the substantially equivalent acceleration feeling. As described above in the embodiment, the amount of battery assist varies according to the accelerator opening change rate ΔAcc. The accelerator opening change rate ΔAcc may thus be regulated to ensure the driver's desired acceleration feeling or to restrict the acceleration and improve the fuel consumption.

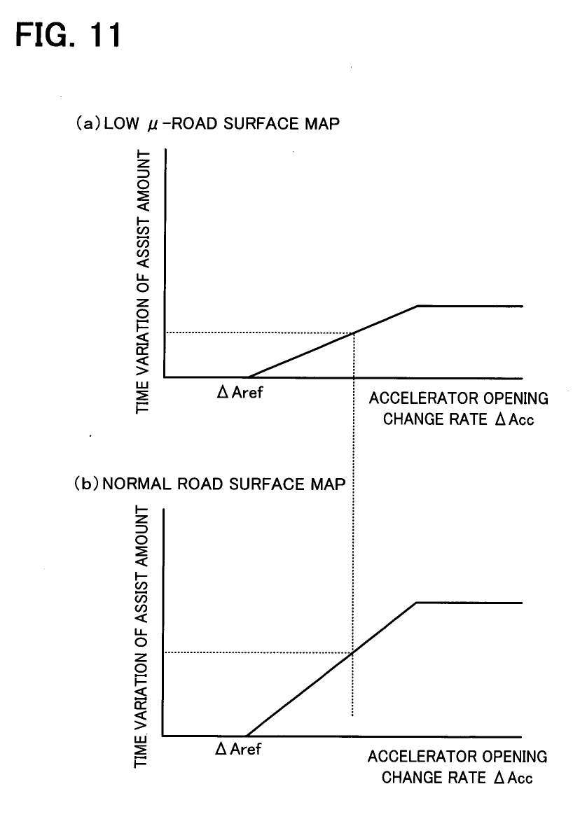

(3) Another modified flow of the drive control routine of FIG. 3 calculates a slip ratio of the drive wheels 63,63 from the differences between the vehicle speed V and the drive wheel speeds Vw and selects an adequate battery assist map corresponding to the calculated slip ratio at step S120. The battery assist map for the economic mode is used as a low μ-road surface map as shown in FIG. 11(a). The battery assist map for the ordinary mode is used as a normal road surface map as shown in FIG. 11(b). When the calculated slip ratio is within a preset slip ratio range of low μ-road surface (for example, not lower than 20%), it is determined that the fuel cell vehicle 10 is currently driven on the low μ-road surface (having a low road surface friction coefficient μ). In this case, the low μ-road surface road map is selected as the adequate battery assist map. When the calculated slip ratio is out of the preset slip ratio range of low μ-road surface, on the other hand, it is determined that the fuel cell vehicle 10 is currently driven on the normal road surface (having a high road surface friction coefficient μ). In this case, the normal road surface map is selected as the adequate battery assist map. This modified application ensures the adequate setting of the amount of battery assist according to the road surface friction coefficient μ and thereby improves the drivability and the fuel consumption. The road surface with the low road surface friction coefficient μ generally has higher slipping tendency than the road surface with the high road surface friction coefficient μ. The reduced assist amount desirably prevents abrupt application of a large torque and thereby enhances the drivability. As described above in the embodiment, the amount of battery assist varies according to the accelerator opening change rate ΔAcc. The accelerator opening change rate ΔAcc may thus be regulated to ensure the driver's desired acceleration feeling or to restrict the acceleration and improve the fuel consumption on the normal road surface having relatively low slipping tendency, while being regulated to prevent the occurrence of slip on the low μ-road surface having relatively high slipping tendency.

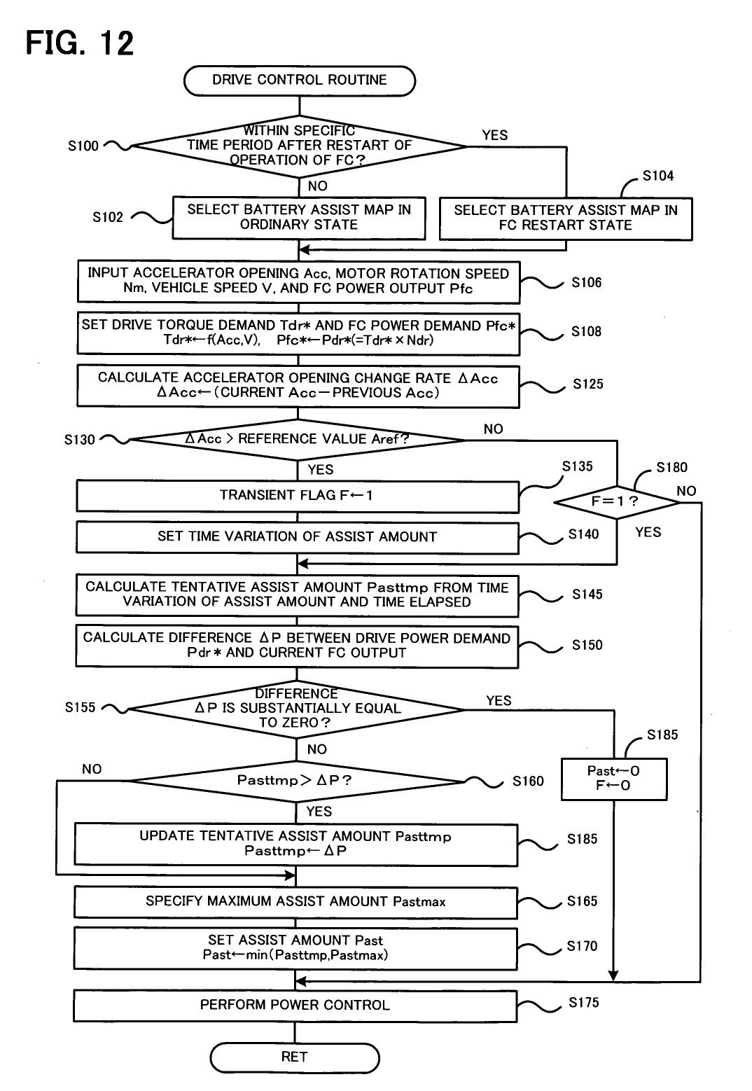

In another application, the drive control routine of FIG. 3 may be replaced by a modified drive control routine shown in FIG. 12. The modified drive control routine of FIG. 12 is similar to the drive control routine of FIG. 3 with replacement of steps S110 to S120 with steps S100 to S108. Only the different points are described below. As the premises, the CPU 72 of the electronic control unit 70 stops the supplies of hydrogen and the air to the fuel cell stack 30 to stop the operation of the fuel cell stack 30, upon satisfaction of a predetermined operation stop condition (for example, the condition that the FC power demand Pfc* is lowered to an undesired level of causing a poor operation efficiency of the fuel cell stack 30). Upon satisfaction of a predetermined operation restart condition (for example, the condition that the electric power required for the fuel cell vehicle 10 is not coverable by the output power of the battery 58 alone), the CPU 72 of the electronic control unit 70 resumes the supplies of hydrogen and the air to restart the operation of the fuel cell stack 30.

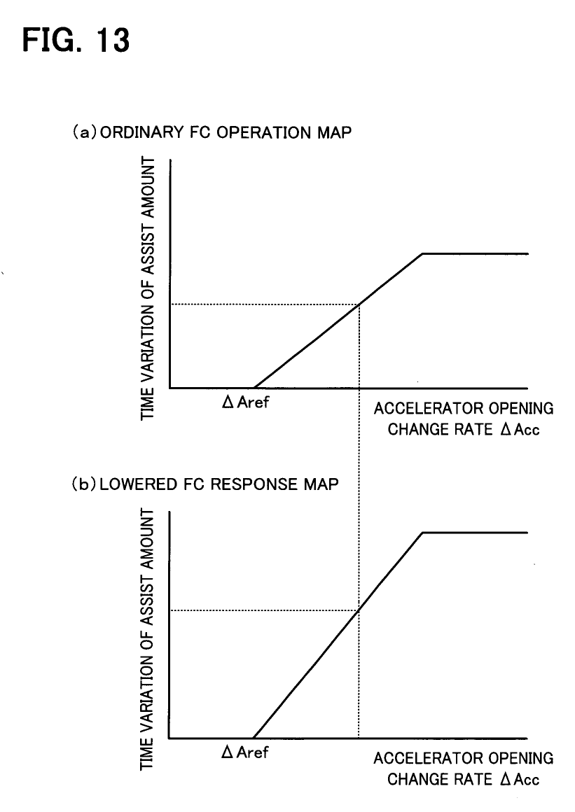

On the start of the modified drive control routine of FIG. 12, the CPU 72 of the electronic control unit 70 first determines whether the current moment is within a specific time period after restart of the operation of the fuel cell stack 30 (step S100). The fuel cell stack 30 has a poorer response of fuel cells for some time period after restart of the operation, compared with a response in the ordinary state. This time period is determined as a result of repeated experiments and is set as the specific time period. When it is determined at step S100 that the current moment is out of the specific time period, the CPU 72 selects an ordinary FC operation map shown in FIG. 13(a) as a battery assist map in the ordinary state (step S102). When it is determined at step S100 that the current moment is within the specific time period, on the other hand, the CPU 72 selects a lowered FC response map shown in FIG. 13(b) as a battery assist map in the operation restart state (step S104). Namely the assist amount is increased in the specific time period after restart of the operation of the fuel cell stack 30, compared with the assist amount in the ordinary state. The battery assist map for the ordinary mode is used as the ordinary FC operation map, whereas the battery assist map for the sports mode is used as the lowered FC response map. The CPU 72 subsequently inputs various data required for control (step S106) and sets the drive torque demand Tdr* to be output to the driveshaft 64 linked with the drive wheels 63,63 as the torque required for the fuel cell vehicle 10 and the FC power demand Pfc* required for the fuel cell stack 30, based on the input accelerator opening Acc and the input vehicle speed V (step S108). The subsequent flow of the modified drive control routine is identical with the drive control routine of the embodiment shown in FIG. 3 and is thus not specifically described here. As mentioned above, the specific time period after restart of the operation of the fuel cell stack 30 has the poorer power generation response of the fuel cell stack 30, compared with the response in the ordinary state. The increased assist amount of the good-response battery 58 effectively improves the overall power output response and prevents deterioration of the drivability. As described above in the embodiment, the amount of battery assist varies according to the accelerator opening change rate ΔAcc. The accelerator opening change rate ΔAcc may thus be regulated to ensure the driver's desired acceleration feeling or to restrict the acceleration and improve the fuel consumption.

The present application claims the priority from Japanese Patent Application No. 2005-226684 filed on Aug. 4, 2005, all the contents of which are hereby incorporated by reference into this application.

### INDUSTRIAL APPLICABILITY

The technique of the invention is applicable to vehicle-related industries including automobiles, buses, and motor lorries.

1. A fuel cell vehicle, comprising:
a motor that is driven to rotate wheels;
fuel cells that generate electrical energy through an electrochemical reaction of a fuel gas and an oxidizing gas;
an accumulator that is charged with electrical energy and is discharged to output electrical energy;
a drive mode detector that detects a drive mode set by a driver;
a power demand setting module that is configured to set a power demand;
a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the drive mode detected by the drive mode detector; and
a controller that controls the fuel cells and the motor to enable a level of electrical energy actually output from the fuel cells to the motor and a level of electrical energy actually output from the accumulator to the motor to be consistent with the respective target values of electrical energy set by the target value setting module.

2. The fuel cell vehicle in accordance with claim 1, wherein the drive mode detector detects the driver's set drive mode among multiple different drive modes including at least a fuel consumption priority drive mode and an acceleration priority drive mode, and
the target value setting module sets, in response to the increase of the power demand, the target value of electrical energy to be output from the accumulator to the motor based on the drive mode detected by the drive mode detector, such that a greater value is set to the target value of electrical energy in the acceleration priority drive mode than the target value of electrical energy in the fuel consumption priority drive mode.

3. The fuel cell vehicle in accordance with claim 1, the fuel cell vehicle further having:
an acceleration intention parameter specification module that specifies an acceleration intention parameter related to the driver's acceleration intention,
wherein the target value setting module sets, in response to the increase of the power demand, the target value of electrical energy to be output from the accumulator to the motor, based on both the drive mode detected by the drive mode detector and the acceleration intention parameter specified by the acceleration intention parameter specification module.

4. The fuel cell vehicle in accordance with claim 3, the fuel cell vehicle further having:
a storage module that is configured to store a variation in target value of electrical energy to be output from the accumulator to the motor against the acceleration intention parameter related to the driver's acceleration intention, which is provided for each drive mode,
wherein the target value setting module sets, in response to the increase of the power demand, the target value of electrical energy to be output from the accumulator to the motor based on the drive mode detected by the drive mode detector, by reading out a corresponding variation provided for the drive mode detected by the drive mode detector from the storage module and referring to the corresponding variation to set the target value of electrical energy to be output from the accumulator to the motor corresponding to the acceleration intention parameter specified by the acceleration intention parameter specification module.

5. The fuel cell vehicle in accordance with claim 1, wherein the drive mode detector is either a drive mode switch or a gearshift position sensor.

6. A fuel cell vehicle, comprising:
a motor that is driven to rotate wheels;
fuel cells that generate electrical energy through an electrochemical reaction of a fuel gas and an oxidizing gas;
an accumulator that is charged with electrical energy and is discharged to output electrical energy;
a vehicle speed detector that detects a vehicle speed;
a power demand setting module that is configured to set a power demand;
a target value setting module that is configured to set a target value of electrical energy to be output from the fuel cells to the motor and a target value of electrical energy to be output from the accumulator to the motor according to the set power demand, such that in response to an increase of the power demand, a greater target value of electrical energy to be output from the accumulator to the motor is set in a high vehicle speed range than the target value of electrical energy in a low vehicle speed range; and
a controller that controls the fuel cells and the motor to enable a level of electrical energy actually output from the fuel cells to the motor and a level of electrical energy actually output from the battery to the motor to be consistent with the respective target values of electrical energy set by the target value setting module.

7. (canceled)

8. The fuel cell vehicle in accordance with claim 6, the fuel cell vehicle further having:
an acceleration intention parameter specification module that specifies an acceleration intention parameter related to the driver's acceleration intention,
wherein the target value setting module sets, in response to an increase of the power demand, the target value of electrical energy to be output from the accumulator to the motor, based on both the vehicle speed detected by the vehicle speed detector and the acceleration intention parameter specified by the acceleration intention parameter specification module.

9. The fuel cell vehicle in accordance with claim 8, the fuel cell vehicle further having:
a storage module that is configured to store a variation in target value of electrical energy to be output from the accumulator to the motor against the acceleration intention parameter related to the driver's acceleration intention, which is provided for each preset vehicle speed range,
wherein the target value setting module sets, in response to the increase of the power demand, the target value of electrical energy to be output from the accumulator to the motor based on the vehicle speed detected by the vehicle speed detector, by reading out a corresponding variation provided for a vehicle speed range of the vehicle speed detected by the vehicle speed detector from the storage module and referring to the corresponding variation to set the target value of electrical energy to be output from the accumulator to the motor corresponding to the acceleration intention parameter specified by the acceleration intention parameter specification module.

10. The fuel cell vehicle in accordance with claim 6, wherein the vehicle speed detector detects a rotation speed of the motor in a structure of direct linkage of an axle of the fuel cell vehicle with a rotating shaft of the motor.

11. A fuel cell vehicle, comprising:
a motor that is driven to rotate wheels;
fuel cells that generate electrical energy through an electrochemical reaction of a fuel gas and an oxidizing gas;
an accumulator that is charged with electrical energy and is discharged to output electrical energy;
a slope detector that detects an uphill slope of road surface;
a power demand setting module that is configured to set a power demand;
a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the uphill slope detected by the slope detector; and
a controller that controls the fuel cells and the motor to enable a level of electrical energy actually output from the fuel cells to the motor and a level of electrical energy actually output from the battery to the motor to be consistent with the respective target values of electrical energy set by the target value setting module.

12. The fuel cell vehicle in accordance with claim 11, wherein the target value setting module sets, in response to the increase of the power demand, the target value of electrical energy to be output from the accumulator to the motor based on the uphill slope detected by the slope detector, such that the target value of electrical energy increases with an increase in detected uphill slope.

13. The fuel cell vehicle in accordance with claim 11, the fuel cell vehicle further having:
an acceleration intention parameter specification module that specifies an acceleration intention parameter related to the driver's acceleration intention,
wherein the target value setting module sets, in response to the increase of the power demand, the target value of electrical energy to be output from the accumulator to the motor, based on both the uphill slope detected by the slope detector and the acceleration intention parameter specified by the acceleration intention parameter specification module.

14. The fuel cell vehicle in accordance with claim 13, the fuel cell vehicle further having:
a storage module that is configured to store a variation in target value of electrical energy to be output from the accumulator to the motor against the acceleration intention parameter related to the driver's acceleration intention, which is provided for each preset uphill slope range,
wherein the target value setting module sets, in response to the increase of the power demand, the target value of electrical energy to be output from the accumulator to the motor based on the uphill slope detected by the slope detector, by reading out a corresponding variation provided for an uphill slope range of the uphill slope detected by the slope detector from the storage module and referring to the corresponding variation to set the target value of electrical energy to be output from the accumulator to the motor corresponding to the acceleration intention parameter specified by the acceleration intention parameter specification module.

15. A fuel cell vehicle, comprising:
a motor that is driven to rotate wheels;
fuel cells that generate electrical energy through an electrochemical reaction of a fuel gas and an oxidizing gas;
an accumulator that is charged with electrical energy and is discharged to output electrical energy;
a friction coefficient detector that detects a road surface friction coefficient;
a power demand setting module that is configured to set a power demand;
a target value setting module that is configured to set a target value of electrical energy to be output from the fuel cells to the motor and a target value of electrical energy to be output from the accumulator to the motor according to the set power demand, such that in response to an increase of the power demand, the target value of electrical energy to be output from the accumulator to the motor is set based on the road surface friction coefficient detected by the friction coefficient detector; and
a controller that controls the fuel cells and the motor to enable a level of electrical energy actually output from the fuel cells to the motor and a level of electrical energy actually output from the battery to the motor to be consistent with the respective target values of electrical energy set by the target value setting module.

16. The fuel cell vehicle in accordance with claim 15, wherein the target value setting module sets, in response to the increase of the power demand, the target value of electrical energy to be output from the accumulator to the motor based on the road surface friction coefficient detected by the friction coefficient detector, such that the target value of electrical energy decreases with a decrease in detected road surface friction coefficient.

17. The fuel cell vehicle in accordance with claim 15, the fuel cell vehicle further having:
an acceleration intention parameter specification module that specifies an acceleration intention parameter related to the driver's acceleration intention,
wherein the target value setting module sets, in response to the increase of the power demand, the target value of electrical energy to be output from the accumulator to the motor, based on both the road surface friction coefficient detected by the friction coefficient detector and the acceleration intention parameter specified by the acceleration intention parameter specification module.

18. The fuel cell vehicle in accordance with claim 17, the fuel cell vehicle further having:
a storage module that is configured to store a variation in target value of electrical energy to be output from the accumulator to the motor against the acceleration intention parameter related to the driver's acceleration intention, which is provided for each preset road surface friction coefficient range,
wherein the target value setting module sets, in response to the increase of the power demand, the target value of electrical energy to be output from the accumulator to the motor based on the road surface friction coefficient detected by the friction coefficient detector, by reading out a corresponding variation provided for a road surface friction coefficient range of the road surface friction coefficient detected by the friction coefficient detector from the storage module and referring to the corresponding variation to set the target value of electrical energy to be output from the accumulator to the motor corresponding to the acceleration intention parameter specified by the acceleration intention parameter specification module.

19. A fuel cell vehicle, comprising:
a motor that is driven to rotate wheels;
fuel cells that generate electrical energy through an electrochemical reaction of a fuel gas and an oxidizing gas;
an accumulator that is charged with electrical energy and is discharged to output electrical energy;
a power demand setting module that is configured to set a power demand;
a target value setting module that is configured to set a target value of electrical energy to be output from the fuel cells to the motor and a target value of electrical energy to be output from the accumulator to the motor according to the set power demand, such that a greater value is set to the target value of electrical energy to be output from the accumulator to the motor in a state immediately after restart of operation of the fuel cells than the target value of electrical energy in an ordinary state; and
a controller that controls the fuel cells and the motor to enable a level of electrical energy actually output from the fuel cells to the motor and a level of electrical energy actually output from the battery to the motor to be consistent with the respective target values of electrical energy set by the target value setting module.

20. The fuel cell vehicle in accordance with claim 19, wherein the state immediately after the restart of operation of the fuel cells represents a state of immediately after a restart of the operation of the fuel cells upon satisfaction of a preset fuel cell operation restart condition, which follows a stop of the operation of the fuel cells upon satisfaction of a preset fuel cell operation stop condition.

21. The fuel cell vehicle in accordance with claim 19, the fuel cell vehicle further having:
an acceleration intention parameter specification module that specifies an acceleration intention parameter related to the driver's acceleration intention,
wherein the target value setting module sets the target value of electrical energy to be output from the fuel cells to the motor and the target value of electrical energy to be output from the accumulator to the motor according to the set power demand, such that the target value of electrical energy to be output from the accumulator to the motor is set in the ordinary state based on the acceleration intention parameter specified by the acceleration intention parameter specification module, and a greater value is set to the target value of electrical energy to be output from the accumulator to the motor in the state immediately after the restart of operation of the fuel cells than the target value of electrical energy in the ordinary state.

22. The fuel cell vehicle in accordance with claim 21, the fuel cell vehicle further having:
a storage module that is configured to store a variation in target value of electrical energy to be output from the accumulator to the motor against the acceleration intention parameter related to the driver's acceleration intention, which is provided separately for the ordinary state and for the state immediately after the restart of operation of the fuel cells,
wherein the target value setting module specifies a current operation state of the fuel cells, reads out a corresponding variation provided for the ordinary state or for the state immediately after the restart of operation of the fuel cells according to the specified current operation state of the fuel cells, and refers to the corresponding variation to set the target value of electrical energy to be output from the accumulator to the motor corresponding to the acceleration intention parameter specified by the acceleration intention parameter specification module.

23. The fuel cell vehicle in accordance with claim 3, wherein the acceleration intention parameter specification module specifies a change rate of an accelerator opening, which represents a time variation of the driver's depression amount of an accelerator pedal, as the acceleration intention parameter.

24. the fuel cell vehicle in accordance with claim 8, wherein the acceleration intention parameter specification module specifies a change rate of an accelerator opening, which represents a time variation of the driver's depression amount of an accelerator pedal, as the acceleration intention parameter.

25. The fuel cell vehicle in accordance with claim 13, wherein the acceleration intention parameter specification module specifies a change rate of an accelerator opening, which represents a time variation of the driver's depression amount of an accelerator pedal, as the acceleration intention parameter.

26. The fuel cell vehicle in accordance with claim 17, wherein the acceleration intention parameter specification module specifies a change rate of an accelerator opening, which represents a time variation of the driver's depression amount of an accelerator pedal, as the acceleration intention parameter.
